(19) United States
(12) Patent Application Publication
(10) Pub. No.: US 2018/0307871 A1
(43) Pub. Date: Oct. 25, 2018

(54) SECURITY DISPLAY PROCESSING

(71) Applicant: Micro Focus Software Inc., Wilmington, DE (US)

(72) Inventors: Richard Brent Rollins, South Jordan, UT (US); Brent Rhodes Beachem, South Jordan, UT (US)

(21) Appl. No.: 15/496,258

(22) Filed: Apr. 25, 2017

(51) Int. Cl. G06F 21/84; G09G 3/38; G06T 1/20; G06F 21/62; G06F 21/31

(52) U.S. Cl. CPC G06F 21/84; G09G 3/38; G06T 1/20; G09G 2354/00; G06F 21/31; G09G 2358/00; G06F 21/6245

(57) ABSTRACT

Display data is intercepted before being provided to an input port of a display. A variety of sensor, peripheral device, and/or application input data available to a device interfaced to the display are collected. Sensitive data present in the display data is identified. A determination is made as to whether to modify or block all of the display data or just the sensitive data. Modified data reflective of the determination is provided to the input port for presentation on the display, or the display data is provided to the input port and an electrochromic glass/film of the display is controlled such that just the modified data is visible on the display.

### BACKGROUND

There are many and varied security techniques in the industry for preventing unauthorized access to confidential information (private information). However, once a user obtains authorized access there is very little security in the industry to restrict how that confidential information is viewed on a display of the user-operated device.

As a result, private/personal data can be viewed by other Individuals that happen to be in proximity to the user-operated device when the authorised user views that confidential data. As previously stated, a variety of security measures exist to control initial electronic access and acquisition of the private data; however, once the private data is actively being viewed on a display/monitor of the authorized user's device, security processing, generally, ceases to exist.

Moreover, the existing approaches that attempt proximity-based security are limited in their application. For example, Radio Frequency (RF) Identification (ID) (RFID) badges may allow a surgeon to activate a monitor for viewing confidential health data on a patient when the surgeon is in proximity to the monitor. This approach does not prevent others in proximity to the monitor from also seeing the health data of the patient.

Authentication goggles only displays information to an authenticated wearer of the goggles; there is no consideration of others behind the wearer that may under some circumstances also be able to see what the wearer is seeing. Smart glass or privacy glass can control the opaqueness of windows into rooms; they are not designed for computing device displays/monitors and are user controlled. Polarized films that are placed over monitors restrict the viewing angle (field of view) of a display but also fail to account for individuals in proximity of the display, who may have a good viewing angle to see the data being displayed and they are not based on any configured dynamic input information.

### SUMMARY

Various embodiments of the invention provide methods and a system for security display processing. In an embodiment, a method for security display processing is presented.

Specifically, in an embodiment, data that is provided to a display is intercepted. Next, selective portions of the data are identified based on patterns. Proximity data is obtained from a sensor or a peripheral. Finally, the display is prevented from at least presenting the selective portions based on the proximity data.

### BRIEF DESCRIPTION OF THE DRAWINGS

FIG. 1A is a diagram depicting a system for security display processing, according an example embodiment.

FIG. 1B is a diagram depicting another system for security display processing, according to an example embodiment.

FIG. 1C is a flowchart for a method of security display processing, according to an example embodiment.

FIG. 2 is a diagram of a method for security display processing, according to an example embodiment.

FIG. 3 is a diagram of another method for security display processing, according to an example embodiment.

FIG. 4 is a diagram of still another system for security display processing, according to an embodiment.

### DETAILED DESCRIPTION

A “resource” includes: a user, service, an application, system (groupings of applications, services, and/or hardware devices/virtual devices), a hardware device, a virtual device, directory, data store, a set of devices logically associated with a single processing environment, groups of users, files, combinations and/or collections of these things, etc. A “principal” is a specific type of resource, such as an automated service or user that at one time or another is an actor on another principal or another type of resource. A designation as to what is a resource and what is a principal can change depending upon the context of any given network transaction. Thus, if one resource attempts to access another resource, the actor of the transaction may be viewed as a principal. Resources can acquire and be associated with unique identities to identify unique resources during network transactions.

An “identity” is something that is formulated from one or more identifiers and secrets that provide a statement of roles and/or permissions that the identity has in relation to resources. An “identifier” is information, which may be private and permits an identity to be formed, and some portions of an identifier may be public information, such as a user identifier, name, etc. Some examples of identifiers include social security number (SSN), user identifier and password pair, account number, retina scan, fingerprint, face scan, Media Access Control (MAC) address, Internet Protocol (IP) address, device serial number, etc.

A “credential” is a secret term, phrase, encrypted data, and/or key used for authenticating a principal to a resource (such as a processing environment). Authentication resolves to an identity for the principal, which is assigned access rights and/or access policies that are linked to that identity during interactions between the principal and the resource.

A “processing environment” defines a set of cooperating computing resources, such as machines (processor and memory-enabled devices), storage, software libraries, software systems, etc. that form a logical computing infrastructure. A “logical computing infrastructure” means that computing resources can be geographically distributed across a network, such as the Internet. So, one computing resource at network site X can be logically combined with another computing resource at network site Y to form a logical processing environment. Moreover, a processing environment can be layered on top of a hardware set of resources (hardware processors, storage, memory, etc.) as a Virtual Machine (VM) or a virtual processing environment.

The phrases “processing environment,” “cloud processing environment,” “hardware processing environment,” and the terms “cloud” and “VM” may be used interchangeably and synonymously herein.

Moreover, it is noted that a “cloud” refers to a logical and/or physical processing environment as discussed above.

A “service” as used herein is an application or software module that is implemented in a non-transitory computer-readable storage medium or in hardware memory as executable instructions that are executed by one or more hardware processors within one or more different processing environments. The executable instructions are programmed in memory when executed by the hardware processors. A “service” can also be a collection of cooperating sub-services, such collection referred to as a “system.”

A single service can execute as multiple different instances of a same service over a network.

Various embodiments of this invention can be implemented as enhancements within existing network architectures and network-enabled devices.

Also, any software presented herein is implemented in (and reside within) hardware machines, such as hardware processor(s) or hardware processor-enabled devices (having hardware processors). These machines are configured and programmed to specifically perform the processing of the methods and system presented herein. Moreover, the methods and system are implemented and reside within a non-transitory computer-readable storage media or memory as executable instructions that are processed on the machines (processors) configured to perform the methods.

Of course, the embodiments of the invention can be implemented in a variety of architectural platforms, devices, operating and server systems, and/or applications. Any particular architectural layout or implementation presented herein is provided for purposes of illustration and comprehension of particular embodiments only and is not intended to limit other embodiments of the invention presented herein and below.

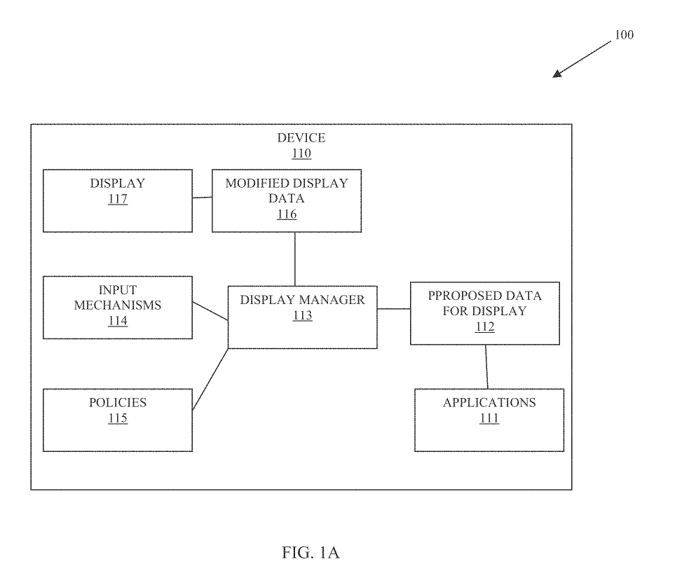

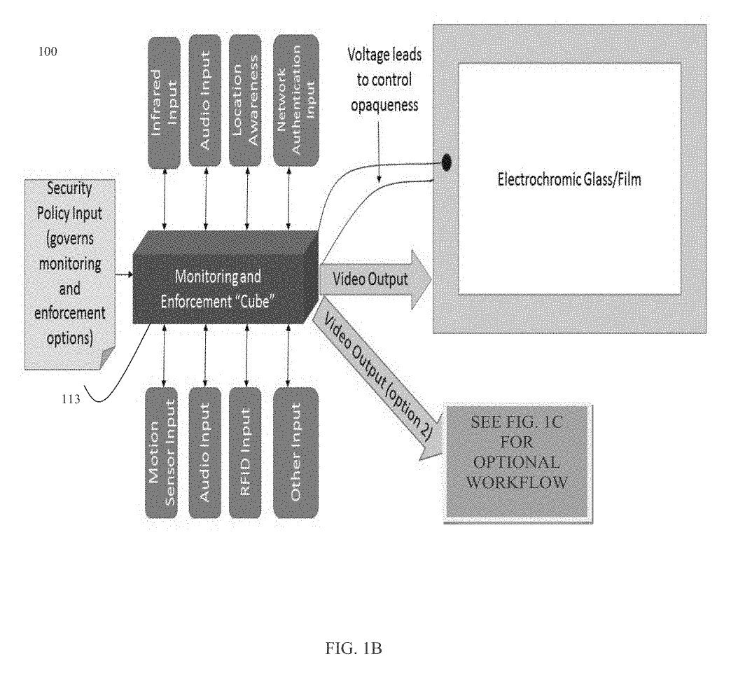

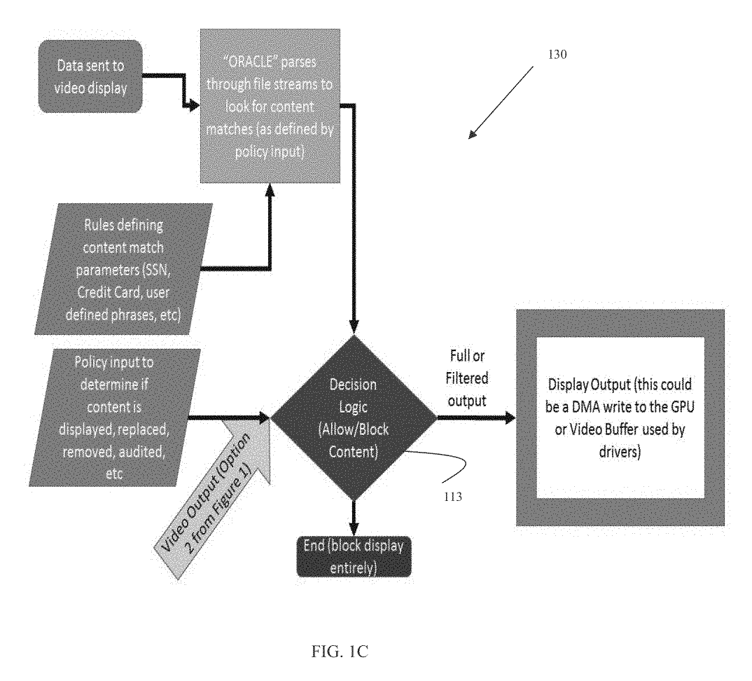

R is within this context that embodiments of the invention are now discussed within the context of the FIGS. 1A-1C and 2-4.

FIG. 1A is a diagram depicting a system 100 for security display processing, according an example embodiment. It is noted that the system 100 is presented as an illustrated embodiment and that other component definitions are envisioned without departing from the embodiments discussed herein. It is also to be noted that only those components necessary for comprehending the embodiments are presented, such that more or less components may be used without departing from the teachings presented herein.

The system 100 includes: a device 110 with the device 110 having a variety of applications/services 111 that produce proposed data for display 112. The device 110 also including a display manager 113 that receives a variety of dynamic and real-time input from input mechanisms 114 and policies 115 for evaluation with the input. The display manager 113 produces modified display data 116 that is presented on one or more screens rendered on a display 117 (integrated within the device 110 or Interfaced to the device 110.

In an embodiment, the device 110 is interfaced through a wired connection to the display 117.

In an embodiment, the device is interfaced through a wireless connection to the display 117 (such as Bluetooth®, Low Energy (LE) Bluetooth®, RF, Wi-Fi, Near Field Communication (NFC), cellular, satellite, etc.).

In an embodiment, the device 110 is interfaced to the display 117 through an integrated data bus connection between a motherboard of the device 110 and the display 117.

In an embodiment, the device 110 is one of: a mobile phone, a tablet computer, a laptop computer, a desktop computer, a server computer, a wearable processing device, a computer integrated into a vehicle, an appliance having computer capabilities that is part of the Internet-of-Things (IoTs), and a specialized Graphics Processing Unit (GPU).

In an embodiment, the applications/services 111 can include any existing installed application/service that executes on the device 110 or a different device through which the device 110 is interfaced to. The applications/services 111 produce output as proposed data for display 112 on the display 117.

In an embodiment, the input mechanisms 114 include one or more sensors, peripheral devices, and services that are interfaced to the device 110. The sensors, peripheral devices, and services can include one or more of: Infrared (IR) sensor(s), microphone(s), camera(s), location awareness service(s) (Global Positioning Satellite (GPS), biometric sensor(s), biometric peripheral device(s), Wi-Fi for determining location, etc.), motion sensor(s), gyroscope(s), network authentication service(s), touch sensor(s), and others.

The policies 115 are conditions that are evaluated in statements for purposes of taking an action with respect to modifying, blocking, or leaving unchanged the proposed data for display 112. The conditions are expressed in terms of the input provided from the input mechanisms 114. The policies 115 can be configured so as to custom-define the statements and actions in view of input received from the input mechanisms 114.

In an embodiment, all or at least some of the policies 115 are dynamically acquired by the device 110 from a network-accessible policy store.

In an embodiment, all or at least some of the policies 115 are dynamically acquired based on one or more of: an identity of a principal (operator of the device 110), an identity of the device 110, an identity of the display 117, a known-physical location of the device 110, a known-physical location of the display 117, a dynamically-resolved physical location of the device 110, an identity of a processing environment processing on the device 110, etc.

In an embodiment, the display 117 is a touch-sensitive display.

In an embodiment, the display 117 includes an electrochromic glass/film, such that voltage leads control the transparency and opaqueness of screens rendered on the display 117 (as shown in the FIG. 1B).

In an embodiment, the display 117 is a digital sign.

In an embodiment, the display 117 is a projector.

In an embodiment, the display 117 is a display integrated into the device 110.

During operation of the system 100, the applications 111 processing on the device 110 or a different device interfaced to the device 110 produce the proposed data for display 112. The proposed data for display 112 is intercepted before it can be provided to the display 117 by the display manager 113.

This can happen in a variety of manners, some of which are described in greater detail below with the FIGS. 1B and 1C. For example, the input into the display 117 can be reconfigured in a hardware-based approach to be routed through the device 110 (as shown in the FIG. 1B below). In devices that utilize Direct Memory Access (DMA) for the display 117 to obtain the data that is to be displayed, the device 110 is a modified GPU (to include the display manager 113), since the CPU produces the data that placed in memory where it is then acquired through DMA from the display 117 (discussed with the FIG. 1C below). When the data that is provided as input to the display 117 is a video card driver, the device (GPU) or other video card is the device 110 having an executing instance of the display manager 113.

Once the display manager 113 has intercepted and obtained the proposed data for display 112, the display manager 113 performs a variety of processing against the proposed data for display 112 to produce modified display data 116 that is then provided to the display 117 (or paced in memory for DMA by the display 117) for rendering the modified display data 116 for presentation on the display 117.

The display manager 113 can process a variety of image, text, video recognition algorithms against the proposed data for display 112 for matching one or more portions of the data 112 to known-patterns associated with known-sensitive, private, personal, and/or confidential data. For example, Social Security Numbers (SSI) have a known pattern of NNN-NN-NNNN comprising 9 characters represented as digits 0-9 and three separators represented by a dash (“-”) character. Other examples include phone numbers, addresses, personal names, dollar amounts, etc. The patterns match to a predefined type (e.g., SSN, name, address, dollar amount, etc.) and can be matched by the display manager 113 using grammars to match portions of the data 112 to a predefined type. Similarly, predefined characteristics of images can be matched by the display manager 113 within the data 112 to predefined types using image and video recognition and feature extraction that maps to the predefined characteristics.

In an embodiment, the display manager 113 may also obtain a context with which the data 112 was produced by the applications 111. The context can identify a variety of information, which may be relevant when evaluating the policies 115. Such information can include, by way of example only: a time of day, day of week, calendar date, identity of the application 111 that produced the data 112, identity of a user operating the device 110, and the like. In an embodiment, the context assist the data manager 113 in obtaining a small set of grammars or image extraction characteristics based on obtaining those grammars or image extraction features associated with the context.

The identified portions of the data 112 are matched to predefined types of security information present in the data 112 by the display manager 113. Next, the display manager 113 determines a proximity context based on the input from the input mechanisms 114 in view of evaluation of the policies 115. The proximity context determines processing actions that the display manager 113 performs on the data to produce the modified display data 116. These actions can remove any, some, or all of the matched predefined types of security information from the data 112 when producing the modified data 116; and/or redact the relevant matched in the data 112 with different data (blacked out, intentionally different bogus data, warning messages indicating that the relevant data cannot be displayed, etc.) when producing the modified data 116.

It is also noted (as discussed in the FIG, 1B) below that the actual data 112 may not be changed at all; rather, the changes to the data 112 can be controlled by controlling the voltage of areas where the relevant security data is being blocked on the display 117, which makes those areas where the relevant security data is being blocked opaque (not visible) on the display 117. That is, the opaqueness can be blocked or turned on, such that areas of the display showing the security data cannot be viewed as well as other areas of the display, such that no data is viewable on the display when the voltage is activated to make the entire viewing area opaque.

These and other embodiments are now discussed with the FIGS. 1B and 1C.

FIG. 1B is a diagram depicting another system 120 for security display processing, according to an example embodiment.

The FIG. 1B represents a device 110 that is integrated into or interfaced to a different device operated by a principal (user or automated application). That is, the FIG. 1B presents a hardware implementation where the device 110 includes the display manager 113 and the device 110 is integrated or interfaced to (wired or wireless) to another device and its display 117.

In an embodiment, the device 110 is a Raspberry Pi® device that includes the display manager 113 executing thereon.

In an embodiment, the device 110 is an Arduino® device.

In an embodiment, the device 110 is an embedded Linux® Operating System (OS) device in a composite device.

A variety of input sensors, peripherals, and/or services (input mechanisms 114) are interfaced to the device 110 (through wired and/or wireless interfaces). An interface (Graphical User Interface and/or Application Programming Interface (API) provides a mechanism for adding, removing, and updating) the security policies 115. A voltage regulator with output controls are also interfaced to the device 110 with the leads attached to an electrochromic glass/film of the display 117.

The display manager 113 uses a combination of input data received from the input mechanisms 114 with the policies 115 to control the opaqueness in select areas of the electrochromic glass/film through the voltage regulator. For example, an RFID badge authentication can be processed to gain access to view sensitive data (such as a surgeon viewing patient health records) along with IR data and motion detection data; a policy 115 includes conditions that just a single person can view the health data within a predefined radius of the display 117, such that the display manager 113 prevents all or some portion of the health data from being displayed even when an authorized surgeon is present with his RFID badge when the sensors (input mechanisms) identify (in accordance with the policy 115) that at least one individual is within 5 feet of the display 117. The health data is prevent from being displayed based on the controlled voltage output from the device 110 to the electrochromic glass/film of the display 117. The display manager 113 can also control polarization of the film of the display 117. In an embodiment, even video streamed content can be controlled in this manner.

The FIG. 1B illustrates a hardware-based implementation of the system 100 as system 120. The FIG. 1C illustrates a custom-software based implementation of the system 100 as method 130.

FIG. 1C is a flowchart for a method 130 of security display processing, according to an example embodiment. In the method 130 the system 100 is implemented in software and drivers of the device 110. The data 112 is analyzed by the display manager 113 for comparing information in the data 112 against predefined rules that govern sensitive data. The video input mechanism for which the data 112 is provided to the display 117 can be existing and legacy-based video hardware (Video Graphics Array (VGA), Desktop Management Interface (DMI), High-Definition Multimedia Interface (HDMI), and other display interface ports) that feeds the display 117 (monitors, projectors, digital signage, device displays, etc.).

In an embodiment, the system 100 includes a combination hardware-based implementation (such as system 120) and software-based implementation (such as method 130). This is illustrated in the FIG. 1B as the box labeled (see FIG. 1C for optional workflow). This approach could then use additional security input processing reflected in the FIG. 1B as output from a first instance of the display manager 113 to the method 130 and a second instance of the display manager 113.

The method 130 changes the data 112 whereas the system 120 does not change the data 112 but controls what is actually available for viewing in the display 117 through the signals sent to the electrochromic glass/film and/or polarization of the film. The method 130 requires no electrochromic glass/film lead connections and can control security information present in all video output devices supported by the device 110.

The inputs to the display 117 are existing known video inputs available to the device 110 combined with any available or interfaced input mechanisms 114. Moreover, the display manager 113 (illustrated as the decision logic in the FIG. 1C) can process existing applications for parsing and identifying patterns and data within context that is present in the proposed data for display 112 (such applications (products) are identified by the box labeled “ORACLE” in the FIG. 1C). The rules or patterns can be fed as input to such products with the data 112 and the output from such products is an indication as to whether or not such patterns were found in the data 112. The display manager 113 can then block the entire data 112 from being presented on the display 117. In an embodiment, such products are enhanced to provide an offset into the data 112 at a start of a particular pattern and a length to indicate an end to the particular pattern, such that specific portions of the data 112 can be blocked or redacted as the modified data 116 presented on the display 117. In an embodiment, such products are enhanced to identify pixel regions where identified patterns are found in the data 112.

When the display 117 and the device 110 employ a GPU and DMA for providing data 112, the processing of the display manager 113 can be integrated as firmware or software processing on the GPU. In an embodiment, such device 110 is modified to bypass the GPU in place of a vide driver that includes the display manager 113.

In an embodiment, the display manager 113 processes on a video card of the device 110 as an enhanced vide driver.

One now appreciates how additional customized display security processing can be provided to devices and displays interfaced to those devices for purposes of enforcing proximity-based and custom-security restrictions on data presented on those displays. This has a variety of benefits to medical professions, road warriors (those that regularly work in the field and out of an office), kiosks (such as Automated Teller Machines ATMs), digital signs, or any situation where access to sensitive data is authorized but is being presented on a display where an additional unauthorized user may be present to view such sensitive data.

As used herein: “sensitive data,” “confidential data,” “personal data,” “private, data,” and “security data” may be used interchangeably and synonymously and refer to data that is predefined as being data requiring authorized access to view. The pattern or rules for defining what is to be sensitive data can be preconfigured.

It is also noted that the display manager 113 can block all of the proposed data for display 112 or can remove, block, and/or modify selection portions of the data 112 identified as sensitive data.

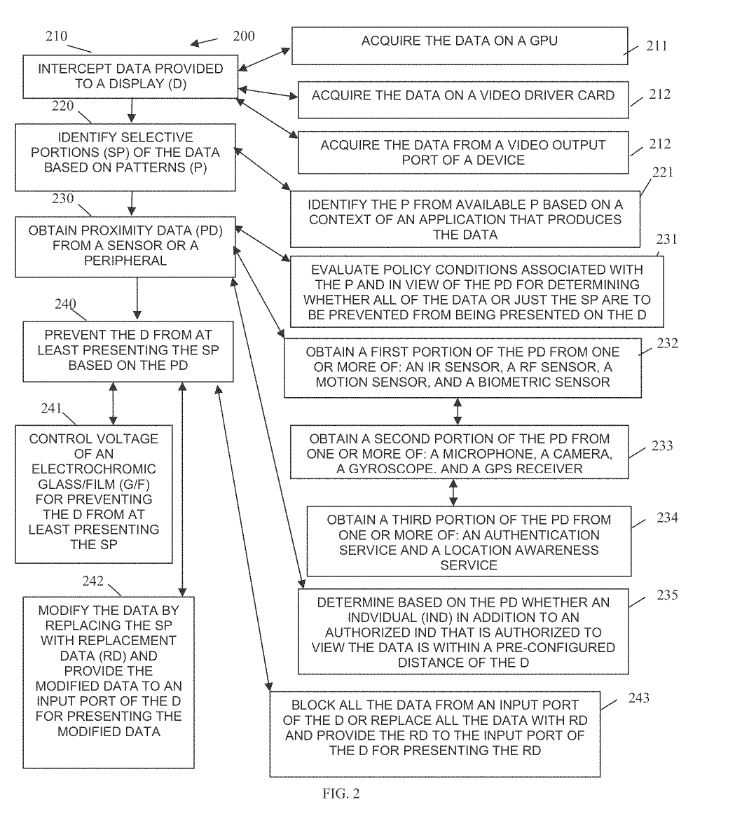

The embodiments discussed above with the FIGS. 1A-1B are now further discussed as well as other embodiments with the FIGS. 2-4.

FIG. 2 is a diagram of a method 200 for security display processing, according to an example embodiment. The method 200 is Implemented as one or more software modules (herein after referred to as a “security display manager”). The security display manager is represented as executable instructions that are implemented, programmed, and resides within memory and/or a non-transitory machine-readable storage media; the executable instructions execute on one or more hardware processors of one or more network devices and have access to one or more network connections associated with one or more networks. The networks may be wired, wireless, or a combination of wired and wireless.

In an embodiment, security display manager is the display manager 113.

In an embodiment, the device that executes the security display manager is the device 110.

At 210, the security display manager intercepts data provided to a display. This can be done in a number of manners such that data produced by an application executing on a device can be prevented from directly providing display data (data) to an input port of the display (which is also interfaced to the device that executes the application).

For example, at 211, the security display manager acquires the intercepted data on a GPU that is integrated on the motherboard of the device that executes the application.

In another case, at 212, the security display manager acquires the intercepted data on a video driver card that is interfaced to the device that executes the application.

In still another case, at 213, the security display manager acquires the data from a video output port of the device that executes the application.

The processing of 211-213 was discussed above with reference to the systems 100, 120, and the method 130.

At 220, the security display manager identifies selective portion of the data based on patterns and/or content pattern recognition rues. Again, this was discussed above with the FIGS. 1A-1C.

In an embodiment, at 221, the security display manager identifies the patterns from a library of available patterns based on a context of an application that produces the display data (data). For example, based on: a time of day, day of week, calendar date, identity of the application, identity of a device that executes the application, and/or an identity of a processing environment that processes on the device.

At 230, the security display manager obtains proximity data for one or more sensors and/or one or more peripheral devices. These can be any of the items discussed above with the input mechanisms 114.

According to an embodiment, at 231, the security display manager evaluates policy conditions associated with the patterns and in view of the proximity data for determining whether all of the display data or just the specific portions of the display data are to be prevented from being presented on the display or by the display.

In an embodiment, at 232, the security display manager obtains a first portion of the proximity data from one or more of: an IR sensor, a RF sensor, a motion sensor, and/or a biometric sensor.

In an embodiment of 232 and at 233, the security display manager obtains a second portion of the proximity data from one or more of: a camera (still or video capable), a microphone, a gyroscope, and a GPS receiver.

In an embodiment of 233 and at 234, the security display manager obtains a third portion of the proximity data from one or more of an authentication service and a location awareness service.

In an embodiment, at 235, the security display manager determines based on the proximity data whether an individual in addition to an authorized individual that is authorized to view the display data within a pre-configured distance of the display.

At 240, the security display manager prevents the display from at least presenting the selective identified portions of the display data based on the proximity data. This can be done in a variety of manners.

For example, at 241 (and as discussed with the FIG. 1B), the security display manager can control a voltage of an electrochromic glass/film of the display for preventing the display from at least presenting the selective identified portions of the display data.

In another case, at 242, the security display manager modifies the data by replacing the selective portions of the display data with replacement data. Then, the security display manager provides the modified data to an input port of the display for presenting the modified display data.

In an embodiment, at 243, the security display manager blocks all of the original display data from an input port of the display or replaces all the original display data with replacement data and provides the replacement data to the input port of the display for presenting the replacement data.

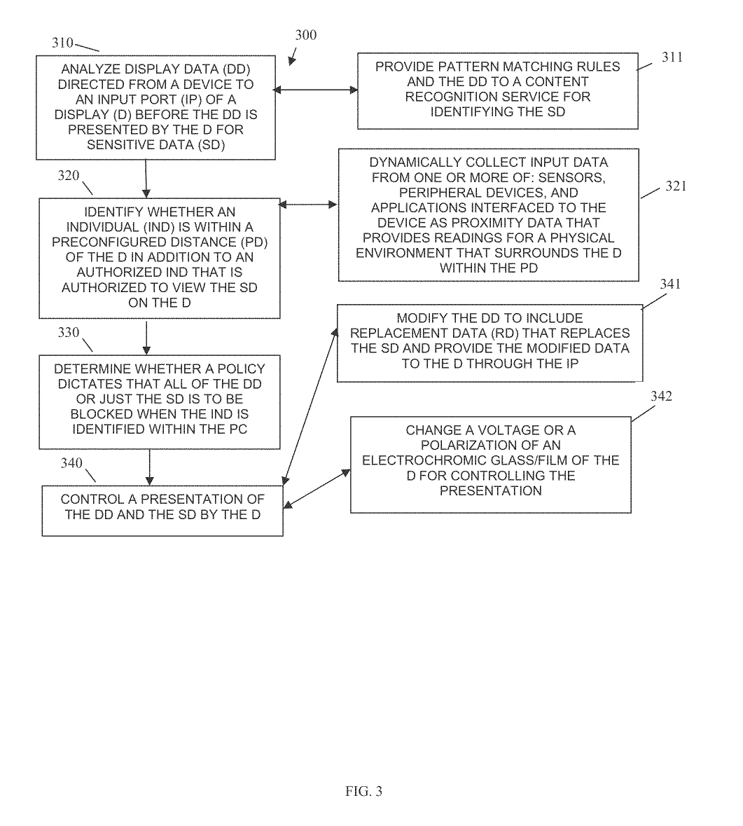

FIG. 3 is a diagram of another method 300 for security display processing, according to an example embodiment. The method 300 is implemented as one or more software module(s) (herein after referred to as a “security display controller”) on one or more hardware devices. The security display controller is represented as executable instructions that are implemented, programmed, and resides within memory and/or a non-transitory machine-readable storage medium; the executable instructions execute on one or more hardware processors of the one or more hardware devices and have access to one or more network connections associated with one or more networks. The networks may be wired, wireless, or a combination of wired and wireless.

In an embodiment, the security display controller is the display manager 113.

In an embodiment, the security display controller is the method 200.

In an embodiment, the security display controller is all or some combination of the display manager 113 and the method 200.

In an embodiment, the device that executes the security display controller is the device 110.

The security display controller presents another and in some ways enhanced processing perspective from that which was presented above in the discussion of the method 200 for the FIG. 2.

At 310, the security display controller analyzes display data directed from a device to an input port of a display before that display data is presented by the display for sensitive data. That is, any sensitive data is recognized and identified in the display data. This was discussed above with the FIG. 1C and the ORACLE component.

According to an embodiment, at 311, the security display controller provides pattern matching rules and the display data to a content recognition service for identifying the sensitive data.

At 320, the security display controller identifies whether an individual is within a preconfigured distance of the display in addition to an authorized individual that is authorized to view the sensitive data on the display.

In an embodiment, at 321 the security display controller dynamically collects input data from one or more of: sensors, peripheral devices, and applications interfaced to the device as proximity data that provides readings for a physical environment that surrounds the display within the preconfigured distance.

At 330, the security display controller determines whether a policy dictates that all of the display data or just the sensitive data of the display data is to be blocked when the individual is identified within the preconfigured distance of the display.

At 340, the security display controller controls a presentation of the display data and the sensitive data.

In an embodiment, at 341 the security display controller modifies the display data to include replacement data that replaces the sensitive data, and the security display controller provides the modified data to the display through the input port of the display. In an embodiment, the input port is a wireless transceiver port. In an embodiment, the input port is a wired port.

According to an embodiment, at 342, the security display controller changes a voltage or a polarization of an electrochromic glass/film for controlling the presentation.

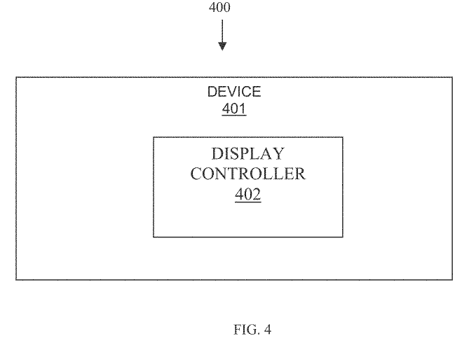

FIG. 4 is a diagram of still another system 400 for security display processing, according to an embodiment. Various components of the system 400 are software module(s) represented as executable instructions, which are programed and/or reside within memory and/or non-transitory computer-readable storage media for execution by one or more hardware devices. The components and the hardware devices have access to one or more network connections over one or more networks, which are wired, wireless, or a combination of wired and wireless.

In an embodiment, the system 400 implements, inter alia, the processing depicted in the FIGS. 1A-1C and the FIGS. 2-3. Accordingly, embodiments discussed above with respect to the FIGS. 1A-1C and 2-3 are incorporated by reference herein with the discussion of the system 400.

The system 400 includes a device 401 having a display controller 402.

In an embodiment, the device 401 is one of: a desktop computer, a laptop computer, a wearable processing device, a tablet computer, a mobile phone, an appliance part of the IoTs, a computer integrated into a vehicle, and a specialized GPU.

In an embodiment, the display controller 402 is all or some combination of: the display manager 113, the method 200, and the method 300.

In an embodiment, the display controller 402 is the display manager 113.

In an embodiment, the display controller 402 is the method 200.

In an embodiment, the display controller 402 is the method 300.

In an embodiment, the server 403 is the credential server 120.

The display controller 402 is configured to: 1) execute on at least one hardware processor of the device 401, 2) intercept display data directed to a display interfaced to the device 401, 3) identify sensitive data present in the display data, and 4) control a presentation of the display data by the display to block all the display data within the presentation or modify the display data within the presentation to prevent the sensitive data from being viewed with the presentation.

Again, and in an embodiment, the device 401 is one of: a laptop, a computer, a desktop computer, a tablet, a server, a wearable processing device, an appliance with computing capabilities that is part of the IoTs, a computer integrated into a vehicle, a GPU integrated into a motherboard of another device, and a video card interfaced to a different device.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

1. A method, comprising;
intercepting data provided to a display;
identifying selective portions of the data based on patterns;
obtaining proximity data from a sensor or a peripheral; and
preventing the display from at least presenting the selective portions based on the proximity data.

2. The method of claim 1, wherein intercepting further includes acquiring the data on a Graphics Processing Unit (GPU).

3. The method of claim 1, wherein intercepting further includes acquiring the data on a video driver card.

4. The method of claim 1, wherein intercepting further includes acquiring the data from a video output port of a device.

5. The method of claim 1, wherein identifying further includes identifying the patterns from available patterns based on a context of an application that produced the data.

6. The method of claim 1, wherein obtaining further includes evaluating policy conditions associated with the patterns and in view of the proximity data for determining whether all of the data or just the selective portions are to be prevented from being presented on the display.

7. The method of claim 1, wherein obtaining further includes obtaining a first portion of the proximity data from one or more of: an infrared (IR) sensor, a motion sensor, a Radio Frequency (RF) sensor, a motion sensor, and a biometric sensor.

8. The method of claim 7, wherein obtaining further includes obtaining a second portion of the proximity data from one or more of: a microphone, a camera, a gyroscope, and a Global Position Satellite (GPS) receiver.

9. The method of claim 8, wherein obtaining further includes obtaining a third portion of the proximity data from one or more of: an authentication service and a location awareness service.

10. The method of claim 1, wherein obtaining further includes determining based on the proximity data whether an individual in addition to an authorized individual that is authorized to view the data is within a pre-configured distance of the display.

11. The method of claim 1, wherein preventing further includes controlling voltage of an electrochromic glass/film of the display or controlling polarization of the electrochromic glass/film for preventing the display from at least presenting the selective portions.

12. The method of claim 1, wherein preventing further includes modifying the data by replacing the selective portions with replacement data and providing the modified data to an input port of the display for presenting the modified data.

13. The method of claim 1, wherein preventing further includes blocking all the data from an input port of the display or replacing all the data with replacement data and providing the replacement data to the input port of the display for presenting the replacement data.

14. A method, comprising:
analyzing display data directed from a device to an input port of a display before the display data is presented by the display for sensitive data;
identifying whether an individual is within a preconfigured distance of the display in addition to an authorized individual that is authorized to view the sensitive data on the display;
determining whether a policy dictates that all of the display data or just the sensitive data is to be blocked when the individual is identified within the preconfigured distance; and
controlling a presentation of the display data and the sensitive data by the display.

15. The method of claim 14, wherein analyzing further includes providing pattern matching rules and the display data to a content recognition service for identifying the sensitive data.

16. The method of claim 14, wherein identifying further includes dynamically collecting input data from one or more: sensors, peripheral devices, and applications interfaced to the device as proximity data that provides readings for a physical environment that surrounds the display within the preconfigured distance.

17. The method of claim 14, wherein controlling further includes modifying the display data to include replacement data that replaces the sensitive data and providing the modified display data to the display through the input port.

18. The method of claim 14, wherein controlling further includes changing a voltage or a polarization of an electrochromic glass/film of the display for controlling the presentation.

19. A system, comprising:
a device; and
a display controller configured to: i) execute on at least one hardware processor of the device, ii) intercept display data directed to a display interfaced to the device, iii) identify sensitive data present in the display data, and iv) control a presentation of the display data by the display to block all the display data within the presentation or modify the display data within the presentation to prevent the sensitive data from being viewed with the presentation.

20. The system of claim 19, wherein device is one of: a laptop, a computer, a desktop computer, a tablet, a server, a wearable processing device, an appliance with computing capabilities that is part of the Internet-of-Things (IoTs), a computer integrated into a vehicle, a Graphics Processing Unit integrated into a motherboard of another device, and a video card interfaced to a different device.
